(19) United States
(12) Patent Application Publication
(10) Pub. No.: US 2026/0192735 A1
(43) Pub. Date: Jul. 9, 2026

(54) MULTI-CHANNEL CARGO RAIL

(71) Applicant: Ford Global Technologies, LLC, Dearborn, MI (US)

(72) Inventors: Javor Gnjidic, Costa Mesa, CA (US); Adwait Bhagwat, Irvine, CA (US); Stephen Jeffrey Moneypenny, San Diego, CA (US); Bradford Zercoe, San Jose, CA (US)

(21) Appl. No.: 19/008,770

(22) Filed: Jan. 3, 2025

(51) Int. Cl. B60P 7/08

(52) U.S. Cl. CPC B60P 7/0815

(57) ABSTRACT

An apparatus comprises one or more rails that extend along a side wall of a cargo area. Each rail comprises an upper channel for a first type of accessory and a lower channel for a second type of accessory. The lower channel is separate from the upper channel, and both the upper channel and the lower channel face inwardly toward the cargo area.

### TECHNICAL FIELD

This disclosure relates generally to an accessory rail system, and relates more specifically to an accessory rail system wherein each rail includes two distinct channels comprising an upper channel for long-term accessories and a lower channel for short-term accessories.

### BACKGROUND

Cargo bed areas in a pickup truck can have many different configurations. Various mounting interfaces may be provided to support different types of accessories such as tonneau covers, cross bars, cargo racks, tie-down cleats, storage containers, and bag hooks, for example. Installing and changing accessories at these mounting interfaces may be challenging.

### SUMMARY

An apparatus according to an exemplary aspect of the present disclosure includes, among other things: at least one rail that is mounted along a side wall defining a cargo area, wherein the at least one rail comprises an upper channel for a first type of accessory and a lower channel for a second type of accessory, wherein both the upper channel and the lower channel face inwardly toward the cargo area, and wherein the lower channel is separate from the upper channel.

In a further non-limiting embodiment of any apparatus, the upper channel has a smaller cross-sectional open area than a cross-sectional open area of the lower channel.

In a further non-limiting embodiment of any apparatus, the first type of accessory comprises a tonneau cover, a cross bar, or a cargo rack, and wherein the second type of accessory comprises a tie-down cleat, a storage container mount, or a hook.

In a further non-limiting embodiment of any apparatus, at least one clamp has an engagement member received within the upper channel, and wherein the engagement member is associated with at least one coupler to secure the first type of accessory to the at least one rail.

In a further non-limiting embodiment of any apparatus, the at least one rail comprises a base wall portion with an upper wall extending from one end of the base wall portion toward the cargo area and a lower wall extending from an opposite end of the base wall portion toward the cargo area, and wherein a rear facing surface of the base wall portion is directly mountable to the side wall of the cargo area.

In a further non-limiting embodiment of any apparatus, the at least one rail comprises an intermediate wall extending from the base wall portion toward the cargo area at a location that is spaced from the upper wall and the lower wall, and wherein the upper channel is formed between the upper wall and the intermediate wall, and the lower channel is formed between the lower wall and the intermediate wall.

In a further non-limiting embodiment of any apparatus, the upper wall includes a first flange extending downwardly toward the intermediate wall, a second flange extending downwardly toward the lower wall, and a third flange extending upwardly from the lower wall toward the intermediate wall.

In a further non-limiting embodiment of any apparatus, the at least one rail includes a first open gap between the first flange and the second flange to provide an opening into the upper channel, and a second open gap between the second flange and the first flange to provide an opening into the lower channel.

In a further non-limiting embodiment of any apparatus, the at least one rail is mounted to the side wall of the cargo area with at least one fastener, and including at least one protector associated with the at least one rail that is moveable between a first position where the at least one fastener is accessible and a second position where the at least one fastener is non-accessible.

In a further non-limiting embodiment of any apparatus, the at least one rail comprises at least a first rail mounted to the side wall of the cargo area and a second rail mounted to an opposite side wall of the cargo area.

An apparatus according to an exemplary aspect of the present disclosure includes, among other things: a first rail having a first mount surface extending along a first side wall defining a cargo area and a first channel portion facing opposite of the first mount surface; a second rail having a second mount surface extending along a second side wall of the cargo area and a second channel portion facing opposite of the second mount surface; and each of the first channel portion and the second channel portion comprises an upper channel for a first type of accessory and a lower channel for a second type of accessory.

In a further non-limiting embodiment of any apparatus, both the upper channel and the lower channel face inwardly toward the cargo area, and wherein the lower channel is separate from the upper channel.

In a further non-limiting embodiment of any apparatus, each of the first rail and the second rail comprises a base wall portion with an upper wall extending from one end of the base wall portion toward the cargo area and a lower wall extending from an opposite end of the base wall portion toward the cargo area, and wherein a rear facing surface of the base wall portion of the first rail is directly mountable to the first side wall of the cargo area and a rear facing surface of the base wall portion of the second rail is directly mountable to the second side wall of the cargo area.

In a further non-limiting embodiment of any apparatus, each of the first rail and the second rail comprises an intermediate wall extending from the base wall portion toward the cargo area at a location that is spaced from the upper wall and the lower wall, and wherein the upper channel is formed between the upper wall and the intermediate wall, and the lower channel is formed between the lower wall and the intermediate wall.

A method according to an exemplary aspect of the present disclosure includes, among other things: providing a first rail and a second rail that each have an upper channel and a lower channel; mounting a rear surface of the first rail along a first side wall of a cargo area such that the upper channel and the lower channel both face the cargo area; mounting a rear surface of the second rail along a second side wall of the cargo area such that the upper channel and the lower channel both face the cargo area; installing a first type of accessory in the upper channel; and installing a second type of accessory in the lower channel.

In a further non-limiting embodiment of any method, the method includes forming each of the first rail and the second rail to have a base wall portion with an upper wall extending from one end of the base wall portion toward the cargo area and a lower wall extending from an opposite end of the base wall portion toward the cargo area, and wherein a rear facing surface of the base wall portion of the first rail is directly mountable to the first side wall of the cargo area and a rear facing surface of the base wall portion of the second rail is directly mountable to the second side wall of the cargo area.

In a further non-limiting embodiment of any method, the method includes forming each of the first rail and the second rail to have an intermediate wall extending from the base wall portion toward the cargo area at a location that is spaced from the upper wall and the lower wall, and forming the upper channel between the upper wall and the intermediate wall, and forming the lower channel between the lower wall and the intermediate wall.

In a further non-limiting embodiment of any method, the method includes forming the upper wall to include a first flange extending downwardly toward the intermediate wall, a second flange extending downwardly toward the lower wall, and a third flange extending upwardly from the lower wall toward the intermediate wall, and wherein a first open gap is provided between the first flange and the second flange to form an opening into the upper channel, and a second open gap is provided between the second flange and the first flange to form an opening into the lower channel.

In a further non-limiting embodiment of any method, the method includes forming each of the first rail and the second rail by extruding from an aluminum material.

In a further non-limiting embodiment of any method, the first type of accessory comprises a tonneau cover, a cross bar, or a cargo rack, and wherein the second type of accessory comprises a tie-down cleat, a storage container mount, or a hook.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a perspective view of an accessory rail system in a cargo area of a truck bed with a tailgate in an open position.

FIG. 2A illustrates a perspective view of an accessory rail system with a protector in an accessible position to allow rails to be attached or detached from a side wall of the truck bed.

FIG. 2B is similar to FIG. 2A but shows the protector in a non-accessible position to prevent the rails from being detached from the side wall of the truck bed.

FIG. 3A illustrates a perspective view of an accessory rail for installation in the cargo area.

FIG. 3B is a section view of the rail of FIG. 3A.

FIG. 4 is a schematic section view of a two-piece rail with an accessory mounted within an upper channel.

FIG. 5 is a schematic section view of a one-piece rail with an accessory mounted in each channel.

### DETAILED DESCRIPTION

This disclosure relates generally to an accessory rail system, and relates more specifically to an accessory rail system wherein each rail includes two distinct channels comprising an upper channel for long-term, e.g., semi-permanently installed, accessories and a lower channel for short-term, e.g., quick change, accessories.

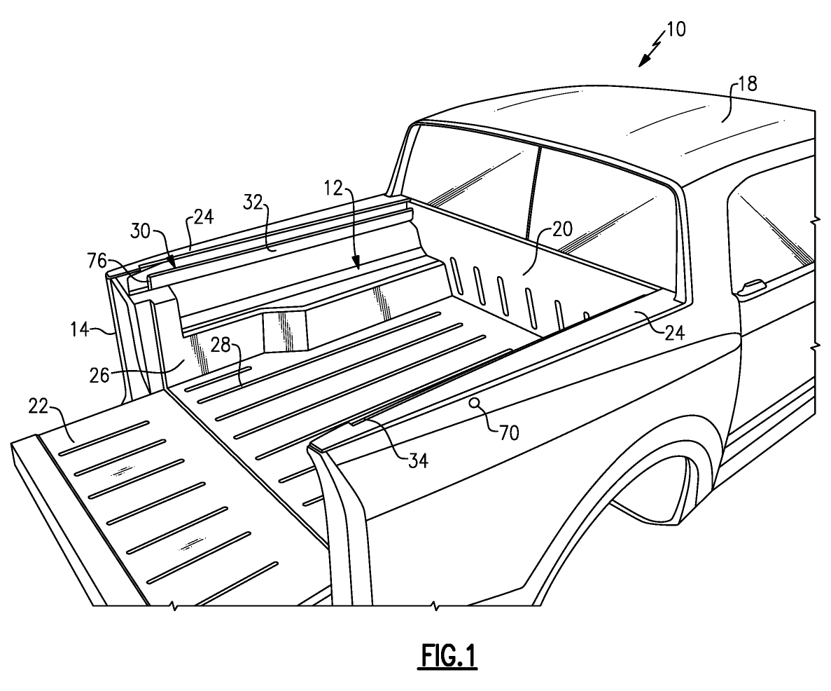

FIG. 1 shows a vehicle 10 with a cargo area 12 defined by a first side wall 14 and a second side wall 16 facing opposite the first side wall 14. A passenger cab 18 is at a front of the vehicle and a front bed wall 20 extends along a back of the passenger cab 18 between the first side wall 14 and the second side wall 16 to enclose a front end of the cargo area 12. A tailgate 22 is positioned at a rear of the vehicle 10 and is moveable between an open position and a closed position.

The first side wall 14 and the second side wall 16 extend along a length of the cargo area 12 in a longitudinal direction, e.g., along a length of the vehicle 10. Each of the first side wall 14 and the second side wall 16 include a top edge or top surface 24 and an inner wall surface 26 that faces the cargo area 12. A bottom bed surface 28 extends in a lateral direction, e.g., across a width of the vehicle 10, between the inner wall surfaces 26 of the first side wall 14 and the second side wall 16. The bottom bed surface 28 also extends in the longitudinal direction from the front bed wall 20 to the tailgate 22.

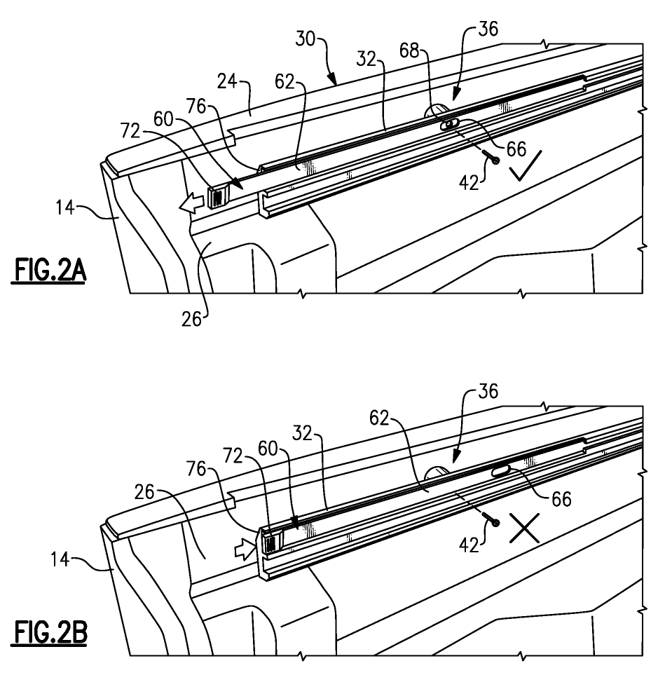

As shown in FIG. 1, an accessory rail system 30 comprises a first rail 32 that is extendable along the first side wall 14 that defines the cargo area 12 and a second rail 34 that is extendable along the second side wall 16. In implementations, the first rail 32 and the second rail 34 each include at least one mount interface 36 (FIG. 2A) to attach to a respective one of the first side wall 14 and the second side wall 16. In implementations, the first rail 32 extends substantially along an entirety of the first side wall 14, and the second rail 34 extends substantially along an entirety of the second side wall 16, from the front bed wall 20 until just short of the tailgate 22.

In some implementations, at least one connector 42 is associated with each mount interface 36. The connectors 42 fix a respective one of the first rail 32 and the second rail 34 to an associated one of the first side wall 14 and the second side wall 16. In one example, the connectors 42 comprise fastening elements such as screws, bolts, etc.; however, other types of connectors could also be used.

In implementations, at least one protector 60 may be associated with the first rail 32 and the second rail 34. The protector 60 is selectively moveable between a first position where the connectors 42 are accessible and a second position where the connectors 42 are non-accessible.

One example of a protector 60 is shown in FIGS. 2A-2B. In this example, the protector 60 comprises a bar 62 that is slidably received within a track 64 formed in each of the first rail 32 and the second rail 34. FIGS. 2A-2B only show the first rail 32 on the first side wall 14, it should be understood that the second rail 34 on the second side wall 16 would be similarly configured.

In implementations, each bar 62 includes at least one window or opening 66 such that when the bar 62 is in the accessible position the opening 66 is aligned with the mount interface 36 (FIGS. 2A), and when the bar 62 is in the non-accessible position the opening 66 is not aligned with the mount interface 36 (FIG. 2B).

In one example, each mount interface 36 includes a first mounting opening 68 formed in an associated one of the first rail 32 and the second rail 34, and a second mounting opening 70 (schematically shown in FIG. 1) formed in an associated one of the first side wall 14 and the second side wall 16. The connector 42 is insertable through the first mounting opening 68 and the second mounting opening 70 to fix a respective one of the first rail 32 and the second rail 34 to an associated one of the first side wall 14 and the second side wall 16.

As shown in FIG. 2A, when the bar 62 is in the accessible position, the opening 66 is aligned with the first mounting opening 68 and the second mounting opening 70. As shown in FIG. 2B, when the bar 62 is in the non-accessible position the opening 66 is not aligned with the first mounting opening 68 and the second mounting opening 70.

The protector 60 is just one example of a device that can be used to prevent the rails from being removed from the vehicle. Additional details regarding protectors can be found in application number 18/786,500, filed on July 28, 2024, which is assigned to the same assignee as the subject application, and which is herein incorporated by reference in its entirety.

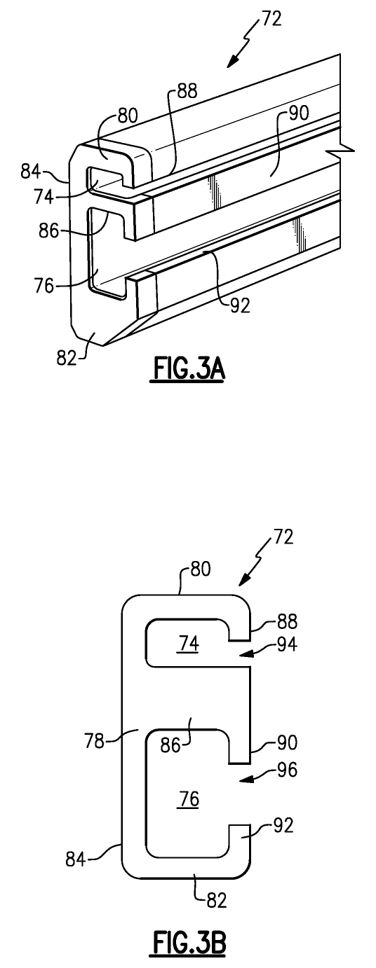

FIGS. 3A-B show one example of a rail 32, 34. In this example, the rail comprises a rail body 72 that includes an upper channel 74 and a lower channel 76.

In some implementations, the rail body 72 comprises a one-piece, extruded aluminum part (see FIGS. 3A-B and 5).

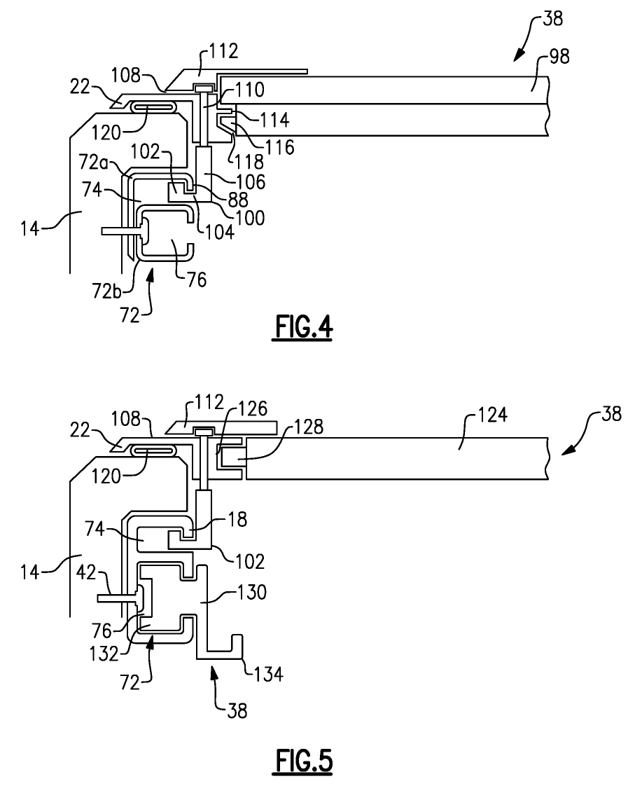

In some implementations, the rail body 72 is formed from two pieces 72a, 72b that are attached to each other (see FIG. 4). In this example, the components may be comprised of rolled steel.

In some implementations, the upper channel 74 has a smaller cross-sectional open area than a cross-sectional open area of the lower channel 76 (see FIG. 3B).

In one example, the upper channel 74 and the lower channel 76 would always have different sizes and/or different shapes from each other such that there would not be any installation confusion.

In some implementations, one or more accessories 38 (see FIGS. 4 and 5) are selectively mountable within the upper channel 74 and lower channel 76.

In some implementations, the upper channel 74 is used for installing large, high mounted and long-term bed accessories. Examples of such accessories include tonneau covers, cross bars, cargo shelves, ladder racks, container mounts, etc.

In some implementations, the lower channel 76 is used for all other types of cargo rail accessories. Examples of such accessories include tie-down cleats, bag hooks, molle panels, bike carriers, security cables, add-on storage containers, etc.

In some implementations, the rail body 72 includes a base wall portion 78 with an upper wall 80 extending from one end of the base wall portion 78 toward the cargo area and a lower wall 82 extending from an opposite end of the base wall portion 78 toward the cargo area.

In one example, a rear facing surface 84 of the base wall portion 78 is directly mountable to the inner surface of the side wall 14, 16 of the cargo area 12.

In some implementations, the rail body 72 includes an intermediate wall 86 that extends from the base wall portion 78 toward the cargo area at a location that is spaced from the upper wall 80 and the lower wall 82. The upper channel 74 is formed between the upper wall 80 and the intermediate wall 86, and the lower channel 76 is formed between the lower wall 82 and the intermediate wall 86.

In some implementations, the upper wall 80 includes a first flange 88 extending downwardly toward the intermediate wall 86, a second flange 90 extending downwardly toward the lower wall 82, and a third flange 92 extending upwardly from the lower wall 82 toward the intermediate wall 86.

In some implementations, there is a first open gap 94 between the first flange 88 and the second flange 90 to provide an opening into the upper channel 74, and a second open gap 96 is between the second flange 90 and the third flange 92 to provide an opening into the lower channel 76.

FIG. 4 shows an example of the rail body 72 being comprised of two pieces, 72a, 72b. The pieces can be separately secured together, or the connectors 42 that attach the rails 32, 34 to the side walls 14, 16 can be used to secure the pieces together.

In implementations, the opening 68 in the rail body that receives the connector 42 can either be in the lower channel 76 as shown in FIGS. 4-5 or can be in the upper channel 74 as shown in FIGS. 2A-2B.

In the example of FIG. 4, a tri-fold cover 98 is shown as being installed into the upper channel 74. In this example, one or more clamps 100 have an engagement member 102 received within the upper channel 74, and the engagement member 102 has a channel 104 that receives the first flange 88. The clamp 100 has a body portion 106 that extends upward to connect with a bracket 108 that couples the clamp 100 to the tri-fold cover 98. A threaded fastener 110 extends from the body portion 106, through the bracket 108, and is covered by a top surface seal 112. The bracket 108 includes a support flange 114 for the cover 98 and an associated bolt 116 is received within a bracket channel 118 to hold the cover 98 in place. An additional seal 120 is positioned between the top surface of the wall 14 and a bracket flange 122.

FIG. 5 shows an example of the rail body 72 that is comprised as one-piece. In this example, instead of a tri-fold cover, a sliding cover 124 is installed in the upper channel 74. The attachment structure of this cover 124 is similar to that shown in FIG. 4 but instead of a support flange 114 and channel 118, the bracket 108 includes a sliding track 126 that receives an edge 128 of the cover 124.

FIG. 5 also shows an additional accessory 38 that is installed in the lower channel 76. In this example, the accessory 38 comprises a hook 130 that has a base body 132 in sliding engagement with the channel 76 and an arm 134 that extends outward into the cargo area. As can be seen in FIG. 5, the hook 130 can be easily accessed as the upper and lower channels are separate from each other. This allows the accessories in the lower channel 76 to be quickly and efficiently changed/replaced.

The disclosed rail body allows specific cargo rail functions, e.g., fixed vs. adjustable, to be separated from each other. Additionally, the disclosed rail configuration allows for full use and flexibility for the lower channel by moving fixed, e.g. semi-permanent, applications to the upper channel. There is also increased functionality because each track can be used simultaneously. Installation of fixed bed accessories is further simplified by providing a unique and dedicated interface at the upper channel.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. An apparatus, comprising:
at least one rail that is mounted along a side wall defining a cargo area, wherein the at least one rail comprises an upper channel for a first type of accessory and a lower channel for a second type of accessory, wherein both the upper channel and the lower channel face inwardly toward the cargo area, and wherein the lower channel is separate from the upper channel.

2. The apparatus of claim 1, wherein the upper channel has a smaller cross-sectional open area than a cross-sectional open area of the lower channel.

3. The apparatus of claim 1, wherein the first type of accessory comprises a tonneau cover, a cross bar, or a cargo rack, and wherein the second type of accessory comprises a tie-down cleat, a storage container mount, or a hook.

4. The apparatus of claim 3, including at least one clamp having an engagement member received within the upper channel, and wherein the engagement member is associated with at least one coupler to secure the first type of accessory to the at least one rail.

5. The apparatus of claim 1, wherein the at least one rail comprises a base wall portion with an upper wall extending from one end of the base wall portion toward the cargo area and a lower wall extending from an opposite end of the base wall portion toward the cargo area, and wherein a rear facing surface of the base wall portion is directly mountable to the side wall of the cargo area.

6. The apparatus of claim 5, wherein the at least one rail comprises an intermediate wall extending from the base wall portion toward the cargo area at a location that is spaced from the upper wall and the lower wall, and wherein the upper channel is formed between the upper wall and the intermediate wall, and the lower channel is formed between the lower wall and the intermediate wall.

7. The apparatus of claim 6, wherein the upper wall includes a first flange extending downwardly toward the intermediate wall, a second flange extending downwardly toward the lower wall, and a third flange extending upwardly from the lower wall toward the intermediate wall.

8. The apparatus of claim 7, wherein the at least one rail includes a first open gap between the first flange and the second flange to provide an opening into the upper channel, and a second open gap between the second flange and the first flange to provide an opening into the lower channel.

9. The apparatus of claim 1, wherein the at least one rail is mounted to the side wall of the cargo area with at least one fastener, and including at least one protector associated with the at least one rail that is moveable between a first position where the at least one fastener is accessible and a second position where the at least one fastener is non-accessible.

10. The apparatus of claim 1, wherein the at least one rail comprises at least a first rail mounted to the side wall of the cargo area and a second rail mounted to an opposite side wall of the cargo area.

11. An apparatus, comprising:
a first rail having a first mount surface extending along a first side wall defining a cargo area and a first channel portion facing opposite of the first mount surface;
a second rail having a second mount surface extending along a second side wall of the cargo area and a second channel portion facing opposite of the second mount surface; and
each of the first channel portion and the second channel portion comprises an upper channel for a first type of accessory and a lower channel for a second type of accessory.

12. The apparatus of claim 11, wherein both the upper channel and the lower channel face inwardly toward the cargo area, and wherein the lower channel is separate from the upper channel.

13. The apparatus of claim 11, wherein each of the first rail and the second rail comprises a base wall portion with an upper wall extending from one end of the base wall portion toward the cargo area and a lower wall extending from an opposite end of the base wall portion toward the cargo area, and wherein a rear facing surface of the base wall portion of the first rail is directly mountable to the first side wall of the cargo area and a rear facing surface of the base wall portion of the second rail is directly mountable to the second side wall of the cargo area.

14. The apparatus of claim 13, wherein each of the first rail and the second rail comprises an intermediate wall extending from the base wall portion toward the cargo area at a location that is spaced from the upper wall and the lower wall, and wherein the upper channel is formed between the upper wall and the intermediate wall, and the lower channel is formed between the lower wall and the intermediate wall.

15. A method comprising:
providing a first rail and a second rail that each have an upper channel and a lower channel;
mounting a rear surface of the first rail along a first side wall of a cargo area such that the upper channel and the lower channel both face the cargo area;
mounting a rear surface of the second rail along a second side wall of the cargo area such that the upper channel and the lower channel both face the cargo area;
installing a first type of accessory in the upper channel; and
installing a second type of accessory in the lower channel.

16. The method of claim 15, including forming each of the first rail and the second rail to have a base wall portion with an upper wall extending from one end of the base wall portion toward the cargo area and a lower wall extending from an opposite end of the base wall portion toward the cargo area, and wherein a rear facing surface of the base wall portion of the first rail is directly mountable to the first side wall of the cargo area and a rear facing surface of the base wall portion of the second rail is directly mountable to the second side wall of the cargo area.

17. The method of claim 16, including forming each of the first rail and the second rail to have an intermediate wall extending from the base wall portion toward the cargo area at a location that is spaced from the upper wall and the lower wall, and forming the upper channel between the upper wall and the intermediate wall, and forming the lower channel between the lower wall and the intermediate wall.

18. The method of claim 17, including forming the upper wall to include a first flange extending downwardly toward the intermediate wall, a second flange extending downwardly toward the lower wall, and a third flange extending upwardly from the lower wall toward the intermediate wall, and wherein a first open gap is provided between the first flange and the second flange to form an opening into the upper channel, and a second open gap is provided between the second flange and the first flange to form an opening into the lower channel.

19. The method of claim 15, including forming each of the first rail and the second rail by extruding from an aluminum material.

20. The method of claim 15, wherein the first type of accessory comprises a tonneau cover, a cross bar, or a cargo rack, and wherein the second type of accessory comprises a tie-down cleat, a storage container mount, or a hook.
